(19) United States
(12) Patent Application Publication
(10) Pub. No.: US 2023/0339318 A1
(43) Pub. Date: Oct. 26, 2023

(54) CONTROL MODULE FOR ELECTRONIC ACCELERATOR

(71) Applicant: ANDERSON FREDERICO DE MIRANDA REZENDE, Goinia (BR)

(72) Inventor: ANDERSON FREDERICO DE MIRANDA REZENDE, Goinia (BR)

(21) Appl. No.: 18/020,940

(22) PCT Filed: Aug. 14, 2020
(86) PCT No.: PCT/BR2020/050320

§ 371 Date: Feb. 12, 2023

(51) Int. Cl. B60K 26/04

(52) U.S. Cl. CPC B60K 26/04; B60K 2026/046

(57) ABSTRACT

Intended for vehicles with an electronic accelerating system that changes the signal sent by the accelerator, reducing the response time of the vehicle actuators; integrated with a wireless communication system via application and a customized luminous selector button for interaction between the control module and the user. It consists of an electronic circuit capable of reading the electrical signs of the vehicle and adjusting gain according to the desired performance level.

It has the functions of: original mode, performance gain or level, adjustment of the performance stages, ECO mode for reducing acceleration, accelerator block, valet mode, adjustment of modes, intensity of the button colours, safety adjustments, recovery of Bluetooth password, reduction of accelerator sign, automatic pilot, speed limit, night-time function for automatic changing the intensity of the light, key of presence, graphics of gains.

### FIELD OF INVENTION

This invention refers to the electronic and engineering field and describes a module for controlling the acceleration signal for cars, motorcycles, trucks and any vehicle with an electronic accelerating system, between the accelerator and the electronic control unit, that changes the signal sent by the accelerator, reducing the response time of the vehicle actuators, so that the vehicle responds the accelerations in a faster way, being integrated with a wireless communication system via a compatible app and, preferably, a customized luminous selector button that interacts between the signal control module and the user.

### BACKGROUND OF THE INVENTION

It is known from the evolution of the automobile industry, that many mechanical parts were replaced by electronic systems, provided with various smart functions, as well as increasingly optimized mechanisms. In the case of accelerating systems, when the vehicles were mainly mechanical, the accelerator pedal was connected to the carburettor through a steel cable, thus doing the dosage of the fuel and promoting the increase or reduction of the acceleration of the vehicle, accordingly.

The actual accelerating systems are electronic, made up of an electronic accelerator, a butterfly body and the electronic management centre of the vehicle (known as ECU—Engine Control Unit). When it is actuated, the accelerator of a vehicle sends a signal to the electronic centre, such signal being analog or digital and proportional to the desired acceleration level.

The signal sent is processed later by the electronic centre and reforwarded to the peripheral elements, that is, the electrical and electronic actuators and sensors present in the vehicle. Such peripherals start then, the actions of accelerating and decelerating the car. All the forwarding process and result of the signals from the actuation of the accelerator take a millisecond. Any lag or delay in this response time is sufficient to cause a loss in the resumption of acceleration, reducing the performance of the vehicle, that is very noticeable by the driver.

Searching through the national and international intellectual property database some equipment in the state of art were found that have similar solutions, however they show various disadvantages relating to the object of this patent. For example, the document PI0619352-8 describes a patent more like the object of this patent and presents an accelerating signal amplifier, that, during its operation, simulate a new signal generated from reading the signals coming from the accelerator and sends this new generated signal to the electronic centre. Such solution does not enable the signal originated from the car to reach the centre without interference and does not have a wireless solution with the possibility of communication with a specific and compatible app, nor it enables the percentage control of the gain app of the signals sent to the control centre.

The documents US006044318A, US005625558A and others describe systems of modifying acceleration having a construction and usability totally different from the object described in this patent.

Considering the above set out briefly in the background of the international search of patents, we can affirm that in the state of art there is no solution describing the same functions of use and interaction of the user any system similar to the one described in the control module object of this patent.

### BRIEF DESCRIPTION OF THE DRAWINGS

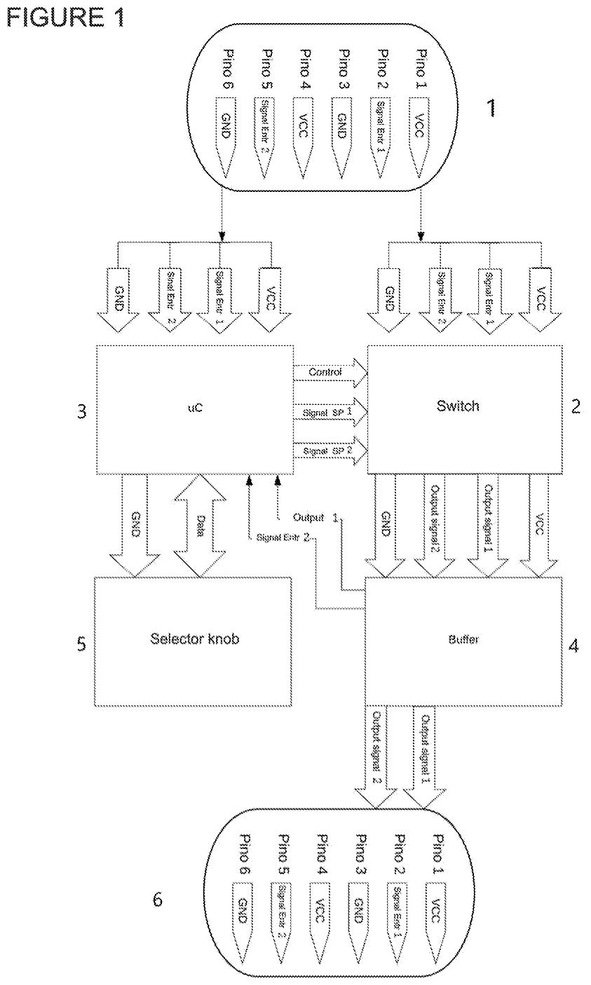

To allow an understanding of the realization of the control module, FIG. 1 is attached, which illustrates the module diagram for controlling the acceleration signal object of this patent.

### DESCRIPTION OF THE INVENTION

This invention refers to the electronic engineering field and describes a module for controlling the accelerating signal for cars, motorcycles, trucks and any vehicle with an electronic accelerating system, between the accelerator and the electronic control unit, that changes the signal sent by the accelerator reducing the response time of the actuators of the vehicle so that the vehicle responds the accelerations in a faster way, such being integrated with a wireless communication system via a compatible app and a customized and preferably luminous selector button.

Said customized luminous button, having an inner electronic circuit with a micro controller responsible for processing the information received in the control module and the information sent when it is pressed down and a RGB LED responsible for illumination with distinct colours for each different function mode chosen.

### Electronic Circuit

The object described in this patent has an electronic circuit capable of reading the vehicle's electrical signals, whether analogue or digital, and adjusting a gain amplifying these signals according to the desired performance level.

The micro controller (3) of the circuit receives the signals sent by the accelerator (1), applies the required algorithm functions, thus whenever the accelerator is pressed down the signal with an applied gain is sent to the buffer (4), that makes current corrections in the signals and sends to the electronic control unit (6) that, on its turn, turns on the actuators and peripheral sensors.

The circuit has a redundancy system that allows, in case of failure or disconnection of the module described in this patent, to ensure that the original signal generated by the vehicle's accelerator continues to be sent to the electronic center without harming the vehicle's driving. This is because the micro controller (3) reads the output signals of the buffer (4) and in if the signals of such reading are different than expected, the circuit causes the switch (2) to close down the original signal, sending the original signal of the vehicle to the electronic control unit without impairing the driving.

The electronic circuit of the module described in this patent has communication with a luminous selector button (5), through the pair of wires making simultaneously the function of supplying the electronic circuit of the button and electric supply thereof. The button has a micro controller and RGB LEDs responsible for showing in different colours each function mode selected in the module object described in this patent.

The circuit has communication with the CAN network of the vehicle, this enabling the module system to identify when the reverse gear is actuated, turning off the signal amplification or reducing to a lower signal, enabling the vehicle not to react in a sudden way during maneuvering moments.

### Luminous Selection Button

The electronic circuit of the button has a micro controller and RGB LEDs, which change the colour according to the function selected by the button or app.

### App

The object described in this patent connects to smartphones, tablets, computers, and the like through a wireless network (wireless), that can be via Bluetooth, Wi-Fi, radio, infrared communication and any other type of wireless remote communication. The communication is closed and has data integrity verification and cryptography. This app enables the user to have access to all the functionalities of the object described in this patent.

Through the app the user may gain access to select the functions of: original mode, performance gain or level, adjustments of the performance stages, ECO mode for reducing the acceleration, accelerator block, valet mode, mode adjustment, intensity of the button colours, safety adjustments, recovery of the Bluetooth password, reduction of the accelerator signal, automatic pilot, speed limit, night-time function for automatic change of the light and intensity of the button colours, key of presence and gain graphics.

The control module contains a failure diagnosis mode to diagnose if the signal received is the same signal expected and if it happens when reading the input signals being the same compared with a standard value of each model. in case the signal received is within the standards, the control module applies the functions, if they are non-compliant with the control module it makes a “bypass” of the original signal of the vehicle and emits an alert on the luminous button leaving the illumination in a red colour intermittent with a white one, it can contain a “beep” or audio signal of alert.

The app allows the change of gain percentages for each stage, wherein the user can select a value from 0 to 100% and even if the last chosen value is stored in the non-volatile memory so the user of the device can make a setup that will remain active until another adjustment is made, both by the button and by the app, prevailing the one that does it last.

The original mode consists of the function of making a keying of the output signal of the accelerator, thus causing the output signal of the accelerator to be the same signal sent to the voltage control unit.

The performance gain mode has five distinct stages, stage “0” being the original one, stage “1” dynamic, stage “2” sport, stage “3” super sport and stage “4” race.

At the original “0” stage, the conditions of the output signal of the accelerator are the same as the signals sent to the electronic control unit, through keying of the input signal to the output.

At the dynamic “1” stage, a gain proportional to 25% more of the input signal at the output is available for the electronic control unit.

At the sport “2” stage, a gain proportional to 50% more of the input signal at the output is available for the electronic control unit.

At the super sport “3” stage, a gain proportional to 75% more of the input signal at the output is available for the electronic control unit.

At the race “4” stage, a gain proportional to 100% more of the input signal at the output is available for the electronic control unit.

In the adjusting mode of the performance stages, we have the following adjustment ways: stage “1” dynamic will be adjusted between 15 and 25%, stage “2” sport will be adjusted between 30 and 50%, stage “3” super sport will be adjusted between 55 and 75″ and stage “4” race will be adjusted between 80 and 100%.

The ECO mode is a mode for reducing acceleration. The module reduces the accelerator signal sent to the electronic managing centre, thus reducing the accelerator answer. Thus when the driver presses the accelerator the module acts reducing sharp starts that wear the mechanical parts of the vehicle, providing a softer exit of the vehicle generating more comfort during driving.

At the mode of accelerator blockage, the function is to block the output signals of the accelerator, thus preventing the use thereof.

The valet mode has the function of limiting the speed of the vehicle, adjusting the proportionality of the accelerator signal between 15 and 45%; the adjustment range will be saved in the non-volatile memory of the control module herein described.

The adjustment way of the modes allows the change of the beginning and end of each gain stage, storing the adjustment values in the non-volatile memory of the control module.

The adjustment mode of the button illumination is aimed at adjusting the intensity of the light brightness of the button in an automatic way through the app, being more intense during the day and less intense at night, all the illumination adjustments will be saved in the non-volatile memory of the control module.

In the security setting mode, four different types of security settings are available: 1) unblocking by presence, 2) valet by attendance, 3) lock password, 4) valet password. The unblocking by presence setting comprises the function of deactivating the blocking function whenever the module is in connection with the app.

The operation at the unblocking by presence adjustment must follow the following criteria: it can be activated or turned off only by the app and when activated, in case the module is turned off and turned on again, the control module must leave the blocking and there will be a new connection.

The valet mode by presence when activated, after the module connects with the app, deactivates it.

At the safety adjustment mode, user is allowed to enable or disable the password request to enter lock mode via app and the user is allowed to enable or disable the password request for entering the valet mode via app.

In Bluetooth password recovery mode, user is allowed to recover original Bluetooth password, in the following way: pressing the button for a time equal or higher than 30 seconds, after such time the illumination of the button must be in the magenta colour, the button should no longer respond to the press until a connection occurs followed by a disconnection via Bluetooth or the module is restarted; the module being in this mode, must allow the user to connect to the unit without needing the password pairing; the module shall enter in the remote programming mode enabling the receipt of AT commands via Bluetooth.

In cruise control mode, speed control is achieved in two ways, the first one being through the GPS speed that is obtained by interpreting the device hardware wherein the app is installed and the second way is through the CAN network of the vehicle itself and also the possibility for the user to define a constant maximum speed at which the vehicle will remain while the function is activated; once selected the maximum limit speed, the control module will not allow the driver to surpass the established speed, even if the driver tries to accelerate more.

At the accelerating graphics mode, the function shows in a graphic way in the compatible app the relation between the original signal and the signal generated by the control module, updating the graphic every 100 milliseconds.

1. CONTROL MODULE FOR ELECTRONIC ACCELERATOR, intended for cars, motorcycles, trucks and any vehicle having an electronic accelerating system, between the accelerator and the electronic control unit, that changes the signal sent by the accelerator reducing the response time of the vehicle actuators and consisting of an electronic circuit capable of reading the electrical signals of the vehicle, either analog or digital and setting a gain amplifying such signals according to the desired performance level, characterized for being integrated with a wireless communication system via a compatible app and a customized selector button, preferably a luminous one having a circuit micro controller (3) receiving the signals sent by the accelerator (1), it applies the required algorithm functions and by the fact that whenever the accelerator is pressed down the applied gain signal is sent to the buffer (4) which makes current corrections on the signals and forwards them to the electronic control unit (6) that, on its turn, activates the actuators and peripheral sensors.

2. CONTROL MODULE FOR ELECTRONIC ACCELERATOR, according to claim 1, characterized by the fact that the electronic circuit has communication with a luminous selector button (5) that has a micro controller and RGB LEDs that change the colour according to the function selected by the button or by the app, its connection being made by a pair of wires that has simultaneously the function of supplying the electronic circuit of the button and electric supply thereof.

3. CONTROL MODULE FOR ELECTRONIC ACCELERATOR, according to claim 1, characterized by the fact that such module is connected to smartphones, tablets, computers and the like through a wireless network, which can be via Bluetooth, Wi-Fi, radio, infrared and any other type of wireless remote communication; said communication being carried out in a closed manner and having data integrity verification and encryption.

4. CONTROL MODULE FOR ELECTRONIC ACCELERATOR, according to claim 1, characterized by the fact that the electronic circuit has a redundancy system which, in case of failure or disability of the control module, allows it to guarantee that the original signal generated by the accelerator of the vehicle carries on being forwarded to the electronic control unit due to the micro controller (3), reads the output signals of the buffer, (4) and in the case the signals of such reading are different than expected, the circuit causes the switch (2) to close down with the original signal.

5. CONTROL MODULE FOR ELECTRONIC ACCELERATOR, according to claim 1, characterized by the fact that the electronic circuit has communication with the CAN network of the vehicle for identifying when the reverse gear is activated to turn off the signal amplification or reduce it to a lower signal.

6. CONTROL MODULE FOR ELECTRONIC ACCELERATOR, according to claim 1, characterized by the fact that it has an app to access the module's functions for selecting:
Original mode,
Performance gain,
Accelerator block,
Valet mode,
Adjustments of modes,
Intensity of the colours of the button,
Safety adjustments,
Performance level,
Recovery of Bluetooth password,
Function of reducing accelerator signal,
Automatic pilot,
Speed limit,
Night-time function for automatic change of the intensity of the light of the button,
Presence key function selection,
Gain graphics.
Said autopilot mode being through the GPS speed by the interpretation of the device's hardware or through the CAN network of the vehicle itself.

7. CONTROL MODULE FOR ELECTRONIC ACCELERATOR, according to claims 1 and 6, characterized by the fact that in the original mode, switching the throttle output signal is the same signal sent to the voltage control unit.

8. CONTROL MODULE FOR ELECTRONIC ACCELERATOR, according to claims 1 and 6, characterized by the fact that the performance gain has five distinct stages and enables the change of the gain percentages of each stage through the app, with the possibility of selecting a value from 0 to 100%, the stages being:
“0” Original—accelerator output signal conditions equal to the signals sent to the electronic control unit, by switching the input signal to the output;
“1” dynamic—a gain proportional to 25% more of the input signal at the output for the electronic control unit;
“2” sport—a gain proportional to 50% more of the input signal at the output for the electronic control unit;
“3” super sport—a gain proportional to 75% more of the input signal at the output for the electronic control unit;
“4” race—a gain proportional to 100% more of the input signal at the output for the electronic control unit;

9. CONTROL MODULE FOR ELECTRONIC ACCELERATOR, according to claims 1 and 6, characterized by the fact that the mode of recovering the Bluetooth password, the user shall press the button for a time equal to or higher than 30 seconds, after this time, the button lighting should turn magenta, the button should no longer respond to pressing until a connection occurs followed by a disconnection via Bluetooth or the module is restarted; the control module in this mode allows the user to be connected without the need for a pairing password; in this way, the control module enters the remote programming mode, enabling the receipt of AT commands via Bluetooth.

10. CONTROL MODULE FOR ELECTRONIC ACCELERATOR, according to claims 1 and 6, characterized by the fact the accelerating graphics mode has the function of demonstrating graphically in the compatible app the relation between the original signal and the signal generated by the control module, updating the graphic every 100 milliseconds.
